(19) United States
(12) Patent Application Publication
(10) Pub. No.: US 2003/0121619 A1
(43) Pub. Date: Jul. 3, 2003

(54) Garage door security device

(76) Inventor: Roman Szpur, Kettering, OH (US)

Correspondence Address: A PATENT LAWYER CORP, PC, R WILLIAM GRAHAM, 22 S ST CLAIR ST, DAYTON, OH, 45402, US

(21) Appl. No.: 10/034,599

(22) Filed: Dec. 28, 2001

(51) Int. Cl. E05F 15/16

(52) U.S. Cl. 160/188

(57) ABSTRACT

A garage door security device for use with a GDOS in a garage to prevent unauthorized access to the garage includes a switch actuator device for actuating and de-actuating an electric current, a female socket operably connected to the switch actuator and for receiving a male plug of the GDOS, a male plug operably connected to the switch actuator and configured to be received within a conventional electric outlet, and wherein the switch actuator includes on/off capabilities to allow or prevent electric current to flow from the electric outlet to the GDOS.

### BACKGROUND OF THE INVENTION

1. Field of the Invention

The present invention relates to garage door security systems and more particularly to electrical devices for preventing unauthorized access to a garage having an electric garage door opener installed on the garage door.

2. Discussion of Prior Art

Electric garage door openers have been a convenience for homeowners for years. For some time now, however, the security in the use of electric garage door openers has been of concern to those same homeowners. The advancement of electronics has provided the ability of thieves to ascertain and duplicate the electronic signal which the homeowner uses to open and close the automatic garage door, thereby, allowing the thief to gain unauthorized access to the interior of the garage and, in many instances, to the interior of the homeowner's home. On the positive side, continued modem technology has created advanced signal devices which automatically and continuously changes the specific signal to activate the garage door opener. However, when the homeowner is away for an extended period of time, such as on vacation, etc., there is ample time for a dedicated thief to positively access the signal code and gain entrance to the garage and/or home. A wide variety of mechanisms have been proposed to prevent unauthorized entry through automatic electronic garage doors. For example, U.S. Pat. No. 5,698,073 discloses a spring-biased lever attached near a lower end of a sectional garage door wherein the lever pivots in response to slack in the door cable to automatically lock the garage door when it is completely shut. The mechanism automatically unlocks the door either when the drive unit is actuated to open the door or when a clutch is utilized to disengage the gear linkage from the motor drive shaft. Some other attempts to prevent unauthorized entry through a garage door are generally exemplified in U.S. Pat. Nos. 2,530,629; 2,607,586; 4,254,582; 4,771,218; and 4,819,379. It has also been common practice to use various key-locking devices for securing the garage door in its closed position. The use of such devices, in many cases, require the manually turning of a locking member such as a key and the inconvenience associated with the locking procedure. Furthermore, electric power would still be provided to the garage door opener so that continued attempts by an unauthorized person to open the garage door may cause damage to the electric motor in the garage door opener. Therefore, a need still exists for a device which will secure an automatic electronic garage door, particularly when the garage door is not being used for an extended period of time.

### SUMMARY OF THE INVENTION

It is a principal object of the present invention to prevent unauthorized entrance to a garage equipped with an automatic electronically operated garage door opener when the garage door is closed.

It is another object of the invention to discontinue electric current to the automatic electronic garage door opener when the garage door is closed.

Typically, automatic electrically operated garage door openers drive the garage door upward or downward on a pair of tracks which flank the garage door opening, when a response to an electric signal is received by an electric motor in the garage door opener housing. The electric signal is usually generated by a manual push-button or by a radio transmitter type control located inside the garage.

In accordance with the present invention, a device capable of being actuated to turn-on and turn-off electric power is coupled to the electric power line that provides electric current from the electric power source to the electric motor in the garage door opener. By actuating the device to disconnect or turn-off the electric power, one positively prevents the garage door from being opened for an indeterminate period of time or until the device is actuated to connect the electric power.

The invention provides garage door security device for use with a GDOS in a garage to prevent unauthorized access to the garage. The device includes a switch actuator device for actuating and de-actuating an electric current, a female socket operably connected to the switch actuator and for receiving a male plug of the GDOS, a male plug operably connected to the switch actuator and configured to be received within a conventional electric outlet, and wherein the switch actuator includes on/off capabilities to allow or prevent electric current to flow from the electric outlet to the GDOS.

### BRIEF DESCRIPTION OF THE DRAWINGS

FIG. 1 is schematic of a garage door opener system (GDOS);

FIG. 2 is a schematic of a GDOS employing a security device of the invention.

FIG. 3 is a schematic of a GDOS employing another embodiment of the security device of the invention.

FIG. 4 is a perspective of the security device in FIG. 3.

FIG. 5 is a perspective of the security device in FIG. 4.

### DETAILED DESCRIPTION OF THE INVENTION

Electric garage door openers typically consist of an electric motor assembly and a drive system which, automatically operates to open and close the garage door. The GDOS can be activated by an electric signal generated by either a manual switch located inside the garage or by a radio signal from a remote hand held transmitter or the like to cause the garage door to travel between open and closed positions. In the standard GDOS, the electric motor is detachably connected to a common electric outlet by an electric cord in much the same manner that most appliances are connected to an electrical outlet, i.e., one end of the electric cord is permanently attached to the motor and the other end of the cord is fitted with a male plug which is easily inserted into the electrical outlet. While this system is effective in providing the convenience of automatically opening and closing the garage door, and is particularly convenient where one approaching the garage in an automobile can simply push the remote control to automatically open the garage door without having to get out of the automobile, such system can be a source of a serious security breach. Modern electronic technology has the ability to allow unscrupulous persons to “steal” the particular electrical signal code used to operate the garage door opener and provide unauthorized access to the garage and, in some instances, to the entire home.

The garage door security described herein is not limited to use with a particular type of garage door or any particular type of garage door opener assembly. For example, the present garage door security system can be used with various well known types of automatic door openers such as elongated, threaded screw type openers as well as roller chain-type drives or cable and pulley type drives.

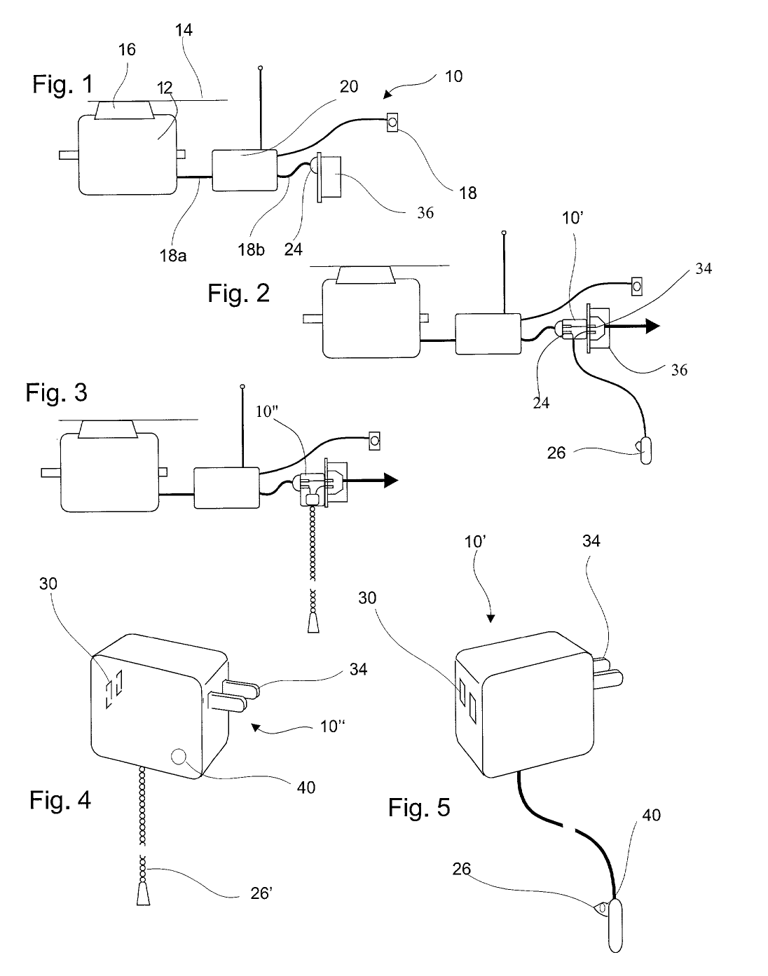

Referring to the drawings, an electrical security device which disables the GDOS and prevents unauthorized access to the garage, is operably connected to the garage door opener assembly and more particularly, on the electric cord between the motor and the electric outlet as illustrated in FIG. 1. As shown in FIG. 1, a garage door opener system (GDOS) 10 includes an electric motor 12 which may be enclosed in a motor housing 13 secured to a garage ceiling 14 by brackets 16. A conventional drive system is operably connected to the motor 12 and can include a support rail and a drive means such as a drive worm gear, a pulley and cable assembly, a chain drive, etc. When electric power is supplied to the electric motor 12 by a conventional manual push-button switch 18, the motor 12 is actuated to open or close the garage door. An electric cord 18a is operably connected to the electric motor 12 and extends from one end thereof and connects to a receiver controller 20. An electric cord 18b operably connects to the receiver controller 20 and has a conventional male plug 24 having at least two prongs for insertion into a corresponding female electrical outlet 36 which is wired for use.

In accordance with the invention, the male plug 24 is operably connected to the security device 10′ of the present invention, as shown in FIG. 2. The security device 10′ includes of an on/off switch actuator 26, a female socket 30 operably connected to a male plug 34 via the actuator 26. As illustrated in FIGS. 2 and 3, the male plug 24 is operably connected to the female socket 30 of the security device 10′ and the male plug 34 of the security device 10′ is operably connected to an electrical outlet 36. The actuator switch 26 may be a pull chain type 26′ or toggle switch 26 or other type switch which can be used to turn electric power on and off. It may be desirable to include a small indicator device 40 such as an indicator light on the actuator switch to show when the switch is on or off.

The garage door security device of the present invention is particularly advantageous where a homeowner arrives home for the evening or intends to be out of the home for an extended period of time, such as on vacation. In such instances, the homeowner simply actuates the security switch 26 to disconnect the electric service to the GDOS as he or she leaves the garage for the evening, or for vacation, or any other time that it is desirable to prevent unauthorized access to the garage and/or home. The security device 10′, 10″ prevents others from gaining unauthorized access to the garage because the electric power to the GDOS has been effectively cut off by the homeowner's actuation of the security switch 26.

Although a particularly preferred embodiment of the invention has been described and illustrated in detail, it is to be understood that various modifications may be make without departing from the spirit and scope of the invention which is defined by the appended claims.

What is claimed is:

1. A garage door security device for use with a GDOS in a garage to prevent unauthorized access to the garage comprising:
a switch actuator device for actuating and de-actuating an electric current;
a female socket operably connected to said switch actuator and for receiving a male plug of said GDOS;
a male plug operably connected to said switch actuator and configured to be received within a conventional electric outlet; and
wherein said switch actuator includes on/off capabilities to allow or prevent electric current to flow from said electric outlet to said GDOS.

2. The assembly of claim 1, further including an on/off switch indicator.

3. The assembly of claim 2, wherein said on/off switch actuator is a pull-type member.

4. The assembly of claim 2 wherein said on/off indicator is an indicator light.

5. In an electric garage door opener system (GDOS) for opening and closing a garage door, said GDOS comprising an electric motor, an electric cord having a male plug for connecting to said electric motor to an electric outlet, and a drive mechanism connected to said garage door wherein said garage door opener is capable of being actuated to open and close said garage door, the improvement which comprises providing an electric garage door security device in the electric cord connecting the garage door opener to the electric outlet, said electric garage door security device comprising:
a switch actuator device for actuating and de-actuating an electric current;
a female socket operably connected to said switch actuator and for receiving the male plug of said GDOS;
a male plug operably connected to said switch actuator and configured to be received within the electric outlet; and
wherein said switch actuator includes on/off capabilities to allow or prevent electric current to flow from said electric outlet to said GDOS.
